(19) United States
(12) Patent Application Publication
(10) Pub. No.: US 2012/0282068 A1
(43) Pub. Date: Nov. 8, 2012

(54) SHELF STORAGE SYSTEM

(75) Inventors: Anton Tschurwald, Graz (AT); Roland Koholka, Lannach (AT)

(73) Assignee: KNAPP AG, Hart bei Graz (AT)

(21) Appl. No.: 13/520,525

(22) PCT Filed: Jan. 3, 2011
(86) PCT No.: PCT/EP2011/050034

§ 371 Date: Jul. 3, 2012

(30) Foreign Application Priority Data
Jan. 14, 2010 (AT) A 40/2010

(51) Int. Cl. B65G 1/04

(52) U.S. Cl. 414/281

(57) ABSTRACT

A shelf storage system comprises shelves having several shelf levels arranged on top of each other. Each shelf level has at least one transport aisle between the shelves with storage spaces for products. In the transport aisle, a level operating device for moving to the storage spaces is provided. At least two lifts take products to the shelf levels and fetch them from there. A conveyor transports products toward the lifts and away from them. The lifts are, in each case, connected both to a supplying and to a removing conveyor and thus are, in each case, designed both for receiving products from the conveyor and for supplying these products to the shelf levels as well as for removing products from the shelf levels and transferring these products onto the conveyor.

The invention relates to a storage system comprising shelves having several shelf levels arranged on top of each other with storage spaces for products, and comprising movable level operating devices for moving to the storage spaces, comprising at least two lifts for taking products to the shelf levels and fetching them from the shelf levels, comprising a conveyor for supplying products to the lifts and removing them from there, comprising intermediate buffers in the shelf levels in which intermediate buffers products supplied by the lifts are stored temporarily until they are transferred onto the level operating device and in which products taken from storage spaces by the level operating device are stored temporarily until they are transferred to the lifts. The storage spaces can also allow multiple-deep storage, i.e., several products are stored one after the other in one storage space.

Such shelf storage systems are also referred to as “shuttle systems”, which is derived from the designation “shuttles” for the level operating devices. Shuttle systems have found wide application in many logistics systems and commissioning systems and are known in different embodiments, see, e.g., DE 10234150 A1. One common feature unites all known shuttle systems: The horizontal and vertical movements of the products while they are placed in storage and removed from storage occur separately.

Shelf storage systems are also known in which the shelf operating device is raised to a conveyor level in order to receive or deliver products there. In such systems, a shelf operating device can be incorporated at any shelf level. These systems are not considered any further here, since their storage/removal-from-storage capacity is relatively small.

In high-performance systems, the shelf operating devices are firmly assigned to the shelf levels. By means of one or several lifts, the products are removed from a shelf level and taken to a conveyor level, which is defined in a prezone, in order to be transported away from there, or, respectively, they are taken in a reverse direction to the conveyor level in order to be transferred to the lift there which will then take the products to the shelf level intended for storage. Since the sum of the transport capacities of all shelf operating devices usually exceeds the capacity of the lift, the throughput of products through the lift constitutes the part of the system which restricts the overall performance.

In each case, one lift is provided for a particular transport direction of the products (placing them in storage or removing them from storage). Accordingly, only one unidirectional connection of the respective lift to the conveyor is provided between the lift and the prezone. This simple and cost-efficient type of lift connection indeed ensures easy control, but restricts the throughput rate of the overall system and creates problems in terms of availability. Namely, if one lift is provided only for placing products in storage and a second lift is provided only for removing products from storage, a malfunction in one of the two lifts will lead to a failure of the overall system, provided that, as is usual practice, the basic concept of the system is that products are to be placed in storage and removed from storage all at the same time. With this connection of the lifts to a conveyor, each of the two lifts thus constitutes a “single point of failure”.

It is thus an object of the present invention to provide a shelf storage system by means of which a high throughput of products is achieved and “single points of failure” are avoided.

This object is achieved by developing further the initially described shelf storage system according to the features of claim 1. Advantageous embodiments of the invention are set forth in the subclaims.

According to the invention, the lifts are, in each case, connected both to a supplying and to a removing conveyor and are, in each case, designed both for receiving products from the conveyor and for supplying these products to the shelf levels as well as for removing products from the shelf levels and transferring these products onto the conveyor. This bidirectional connection of the lifts to the conveyor, whereby all lifts are able to both receive and deliver products, has the major advantage that all lifts are operable equivalently. In case another lift has a breakdown, each lift can thus replace said defective lift. In this way, a “single point of failure” is avoided.

The shelf storage system according to the invention has a substantially higher conveyor capability than known high-bay racking systems. Namely, since, in known high-bay racking systems, one lift is provided only for placing products in storage and a second lift is provided only for removing products from storage, the capacity of the respective lift restricts the maximum number of operations. If, for example, in one period products are only placed in storage, only one lift is used for this, i.e., the capacity of the second lift, which is provided only for removing products from storage, cannot be used. Thus, half of the capacity is wasted. However, according to the invention with a bidirectional connection of all lifts, the entire existing lift capacity can be divided up flexibly, depending on the required operation. In case products are placed in storage, all lifts can be used for placing the products in storage, removing products from storage can likewise be effected with all lifts at the same time. With the shelf storage system according to the invention, any desired distribution of storage and removal-from-storage operations between the lifts can be implemented in terms of control technology. As a result, the possible throughput always increases as compared to conventional high-bay racking systems if the required throughput for one direction (storage and removal from storage, respectively) exceeds the capacity of an individual lift and the opposite direction does not require the full capacity of a lift.

It must the mentioned that the term “product”, as used herein, comprises a commodity as such as well as several individual goods or goods packed into a unit. Furthermore, the transport of the products may be effected both in such a way that the products are conveyed and handled directly and in such a way that the products are contained in a receptacle such as a cup, a box, a cardboard box etc. and are conveyed and placed in and removed from storage in said receptacle.

A shelf storage system according to the invention comprising only a small number of components is obtained if the conveyor connected to the lifts comprises conveying tracks with reversible conveying directions.

On the other hand, a simple mechanical and electrical design of a shelf storage system according to the invention can be obtained if the conveyor connected to the lifts comprises conveying tracks with a conveying direction toward the lifts and conveying tracks with a conveying direction away from the lifts. In a preferred embodiment, two conveying tracks conveying toward the lift and one conveying track conveying away from the lift are provided per lift. In this embodiment, a more uniform utilization of the system is achieved, since the removal of products is normally less time-consuming than the supply because a plurality of level operating devices are provided in the shelf storage system, which level operating devices have a lot of time between moving to the respective level with the lifts for fetching products to be removed from storage from the storage places and transferring them to the intermediate buffer.

An increase in the throughput is achieved in the shelf storage system according to the invention if at least one of the lifts, preferably, however, all lifts, is equipped with at least two lift platforms for carrying products. On the one hand, the lifts can thus be loaded with more products at the same time. On the other hand, it is also possible in terms of control technology to dedicate one of the lift platforms to products to be placed in storage and to dedicate the second lift platform to products to be removed from storage. In terms of control technology, any variant of the distribution of products to be placed in and removed from storage on the lift platforms is feasible, whereby a high throughput of products is achievable.

A further increase in the throughput of products is obtained if the conveyor is arranged such that, in at least one transfer position of the lift, at least two lift platforms are connected to conveying tracks. Thus, it is possible to simultaneously load and/or unload the lift platforms in this transfer position. Only a small space is required for the lift if the lift platforms are arranged on top of each other. Thereby, it is preferred that the vertical distance between the lift platforms corresponds to the vertical distance between the shelf levels, since, in this case, it is possible to perform storage and/or removal-from-storage operations simultaneously at two adjacent shelf levels. When the lift platforms are arranged on top of each other, the conveying tracks toward and/or away from the lift platforms are also arranged on top of each other. Preferably, the vertical distance between at least two conveying tracks thereby corresponds to the vertical distance between the lift platforms so that the lift platforms can be loaded/and or unloaded simultaneously.

In one embodiment of the shelf storage system according to the invention, two conveying tracks conveying toward the lift and one conveying track conveying away from the lift are provided per lift, wherein the conveying track conveying away from the lift is arranged between the conveying tracks conveying toward the lift. Thereby, the lift can be placed in alternating transfer positions in which, in each case, one product is transferred to the conveying track conveying away from the lift and one product is transferred from one of the two supplying conveying tracks onto the lift.

In a further embodiment of the invention, the conveyor is arranged at several conveyor levels the lifts can be moved to. Each of the conveyor levels can be combined with a prezone level, whereby, e.g., one commissioning can be effected in several prezones.

In the following, embodiments of the invention are illustrated in further detail in a non-limiting way, with reference to the drawings.

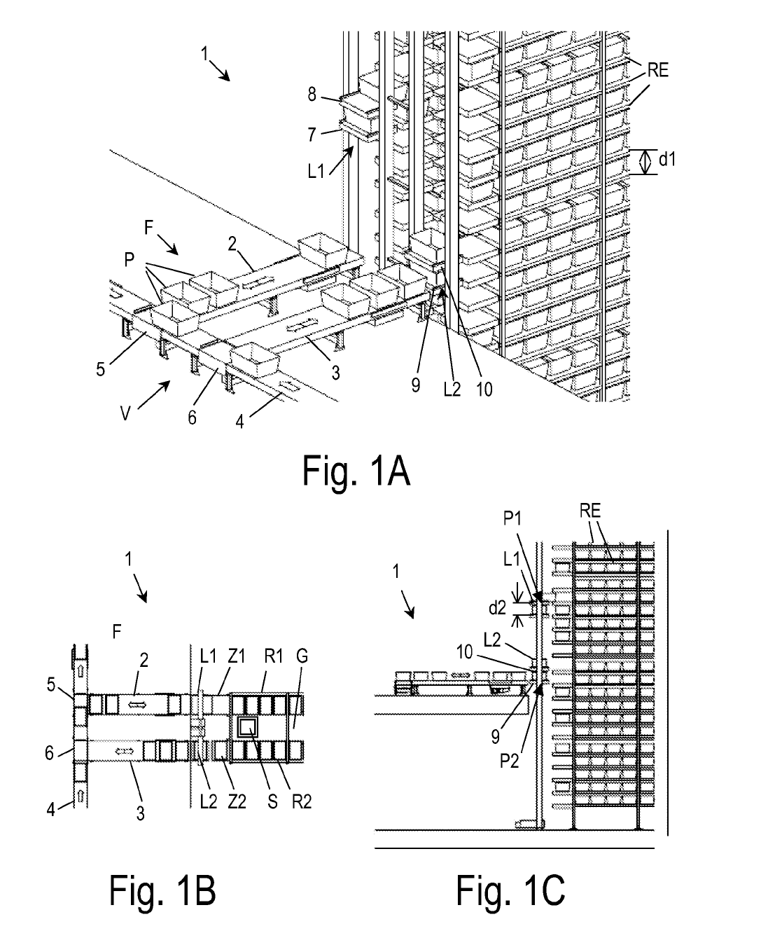

FIGS. 1A, 1B and 1C show a first embodiment of a shelf storage system according to the invention in perspective, in top view and in side view.

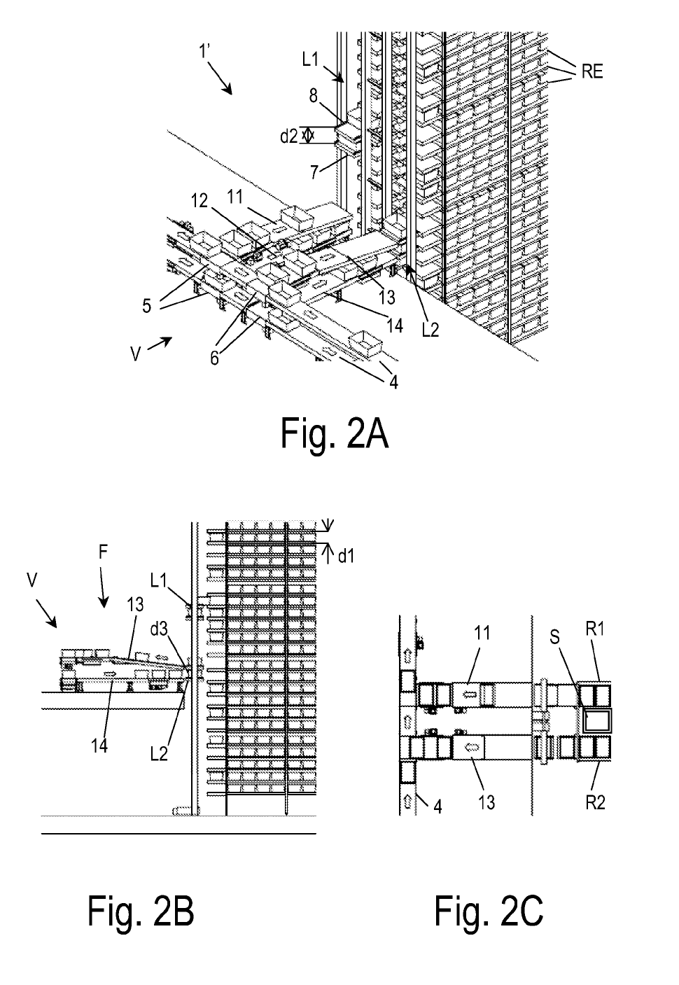

FIGS. 2A, 2B and 2C show a second embodiment of a shelf storage system according to the invention in perspective, in side view and in top view.

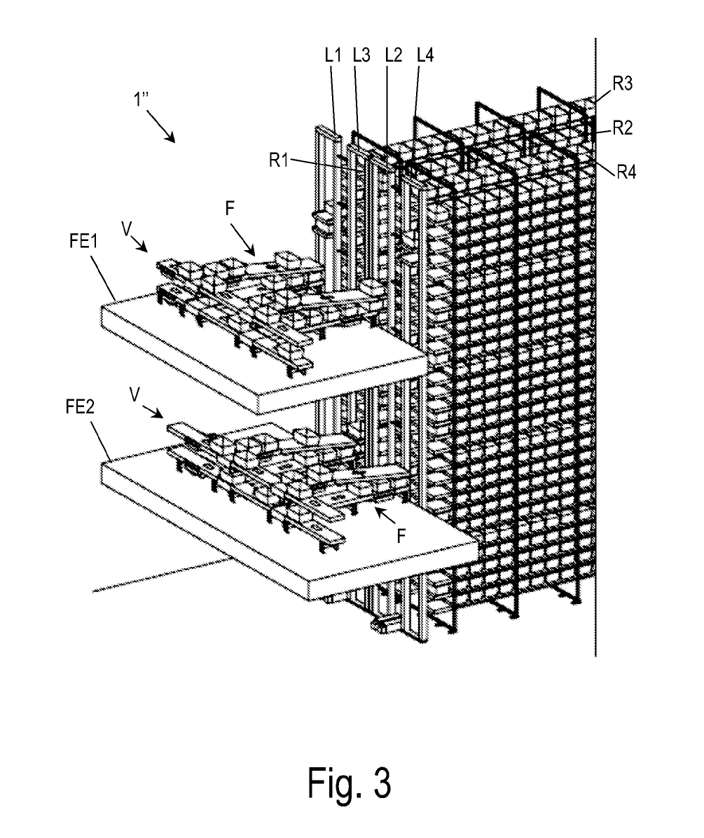

FIG. 3 shows a third embodiment of a shelf storage system according to the invention in perspective.

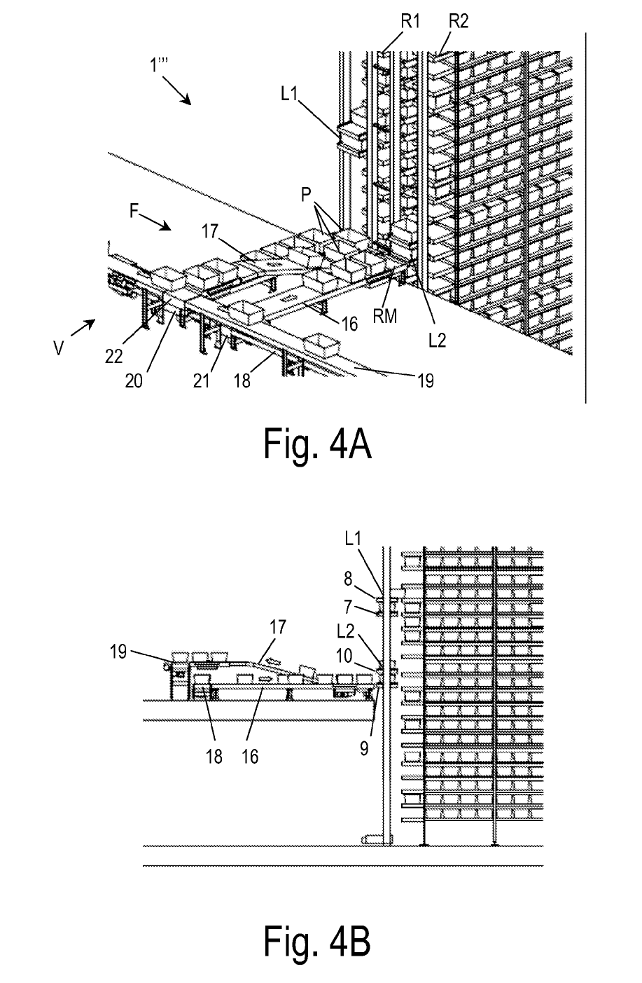

FIGS. 4A, 4B and 4C show a fourth embodiment of a shelf storage system according to the invention in perspective, in side view and in top view.

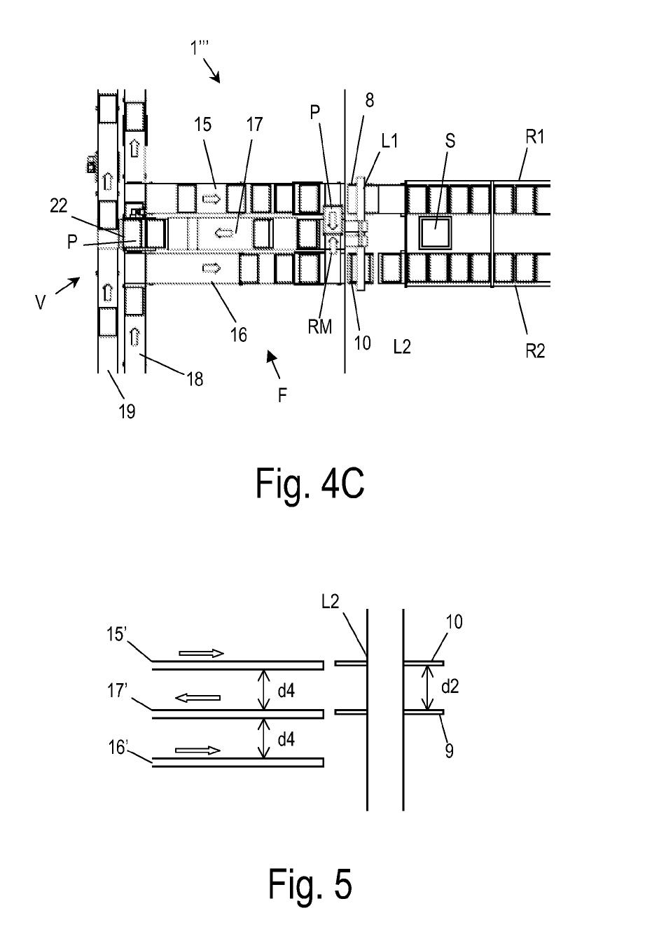

FIG. 5 shows a variant of the fourth embodiment of a shelf storage system according to the invention in side view.

In FIGS. 1A, 1B and 1C, a first embodiment of a shelf storage system 1 according to the invention is illustrated. The shelf storage system 1 comprises shelves R1, R2 between which a transport aisle G is formed. Each of the shelves R1, R2 has a plurality of shelf levels RE arranged on top of each other. At each shelf level RE, a transport aisle G is located between the shelves, with a level operating device S being provided in each transport aisle G which can move back and forth in the transport aisle in order to move to storage spaces in the shelves R1, R2 either for fetching products P from the storage spaces and taking them to an intermediate buffer Z1, Z2 or for storing products P taken from one of the intermediate buffers Z1, Z2 in the storage spaces. The storage spaces can be dimensioned such that multiple-deep storage is possible by storing several products one after the other in one storage space. In a variant of the invention which is not illustrated in the drawing, one level operating device serves several (preferably two) shelf levels RE so that a transport aisle with a level operating device does not have to be arranged at every shelf level. Even if one level operating device serves several shelf levels, at least one intermediate buffer Z1, Z2 can still be arranged per shelf level RE. If level operating devices serve several shelf levels, the arrangement is such that the level operating devices serve the shelf levels in a manner in which they do not overlap each other.

In the drawings, the products P are illustrated by receptacles via which it is symbolized that the term “product”, as used herein, comprises one or several commodities as such, in individual parts or packed into a unit, as well as goods which are transported and stored in a receptacle such as a cup, a box etc.

In the shelf storage system 1, two lifts L1, L2 are provided by means of which products P are taken to the shelf levels RE and transferred there to the intermediate buffers Z1, Z2 and products P stored temporarily in the intermediate buffers Z1, Z2 are fetched from the shelf levels RE. A conveyor F serves for supplying and removing products P to and from the lifts L1, L2, respectively. The conveyor F receives products P from a prezone V and delivers them to the prezone V, respectively.

According to the invention, the lifts L1, L2 are, in each case, connected both to a supplying and to a removing conveyor, which, in this exemplary embodiment, are designed as bidirectional conveying tracks 2, 3, i.e., conveying tracks with a reversible conveying direction. Thus, both lifts L1, L2 can both receive products P from the conveying tracks 2, 3 and deliver products P to the conveying tracks 2, 3, which are then taken away to the prezone V. In this exemplary embodiment, the prezone V comprises a unidirectional conveyor belt 4 having two transfer stations 5, 6 in which products P can be transferred onto the conveying tracks 2, 3 and, respectively, can be received by them.

Each of the lifts L1, L2 is equipped with two lift platforms 7, 8 and 9, 10, respectively, which, in each case, are arranged on top of each other. The vertical distance d2 between the lift platforms 7, 8 and 9, 10, respectively, corresponds to the vertical distance dl between the shelf levels RE. In this way, if a lift, herein, e.g., lift L1, is located in a shelf transfer position P1, products P can be transferred simultaneously to the intermediate buffers of two shelf levels RE lying on top of each other, or products P can be taken simultaneously from the intermediate buffers of two shelf levels RE lying on top of each other and moved onto the lift platforms, or a product can be transferred from one lift platform 7 to the intermediate buffer of one shelf level and a different product can be taken from an intermediate buffer of the adjacent shelf level and moved onto the lift platform 8.

It can be seen in FIG. 1C that the lift L2 is located in a transfer position P2 in which the lower lift platform 9 is flush with the conveying track 3, whereby a product can be transferred from the conveying track 3 onto the lift platform 9 and, respectively, a product can also be transferred reversely from the lift platform 9 onto the conveying track 3. In order to load or unload the upper lift platform 10 of the lift L2, the lift L2 must be moved such that the lift platform 10 reaches the transfer position P2.

By bidirectionally connecting the lifts L1, L2 to the two bidirectional conveying tracks 2, 3, whereby each of the two lifts L1, L2 is designed for receiving products from the conveyor F and for subsequently supplying these products to the shelf levels RE as well as for fetching products P from the shelf levels RE and transferring these products onto the conveyor F, both lifts L1, L2 are operable equivalently. In case another lift L2, L1 has a breakdown, each lift L1, L2 can thus replace said defective lift.

The shelf storage system 1 according to the invention can also be operated such that, in a first time period, products are only stored in the shelves R1, R2 using both lifts L1, L2, and in a second time period, products are only fetched from the shelf levels RE and transferred to the conveyor F using both lifts L1, L2. In general, by means of the shelf storage system 1 according to the invention, the entire existing lift capacity can be divided up flexibly, depending on the required storage and/or removal-from-storage operations, wherein any desired distribution of storage and removal-from-storage operations between the lifts L1, L2 can be implemented in terms of control technology. As a result, the possible throughput of products always increases as compared to conventional high-bay racking systems if the required throughput for one direction (storage and removal from storage, respectively) exceeds the capacity of an individual lift and the opposite direction does not require the full capacity of a lift.

In FIGS. 2A, 2B and 2C, a second embodiment of a shelf storage system 1′ according to the invention is depicted which differs from the first embodiment only by the design of the conveyor F and the prezone V. In FIGS. 2A, 2B and 2C, equal or similar parts of the shelf storage system 1′ are provided with the same reference characters as in the first embodiment of the shelf storage system 1. With regard to a description of those equal or similar parts, the first embodiment is indicated.

In the shelf storage system 1′, the conveyor F is implemented such that, for each lift L1, L2, one conveying track 12, 14 with a conveying direction toward the lifts L1, L2 and one conveying track 11, 13 with a conveying direction away from the lifts L1, L2 are, in each case, provided. Although each of the conveying tracks 11, 12, 13, 14 is a unidirectional conveying track, the conveyor F as a whole is still configured such that each lift L1, L2 is connected, in each case, both to a supplying and to a removing conveyor. Therefore, each lift L1, L2 is designed for receiving products from the conveyor F and for supplying these received products to the shelf levels RE as well as for taking products away from the shelf levels RE and for transferring these products onto the conveyor F.

One conveying track 12, 14 with a conveying direction toward the lifts L1, L2 and one conveying track 11, 13 with a conveying direction away from the lifts L1, L2 are, in each case, arranged on top of each other, namely at a vertical distance d3 from each other which corresponds to the vertical distance d2 between the lift platforms 7, 8 and 9, 10, respectively, lying on top of each other. Thus, both lifts L1, L2 can receive products P from the supplying conveying tracks 12, 14 and can simultaneously deliver products P to the removing conveying tracks 11, 13, which are then taken away to the prezone V. In this exemplary embodiment, the prezone V comprises two unidirectional conveyor belts 4 arranged on top of each other which, in each case, have transfer stations 5, 6 in which products P can be transferred onto the conveying tracks 12, 14 (on the lower conveyor belt 4) and, respectively, products P can be received by the conveying tracks 11, 13 (on the upper conveyor belt 4).

In FIG. 3, a third embodiment of a shelf storage system 1″ according to the invention is depicted which differs from the second shelf storage system 1′ in that the connections of the shelves R1, R2, R3, R4 and of the lifts L1, L2, L3, L4 to a prezone are provided at two conveyor levels FE1, FE2 lying on top of each other. Via a bidirectional conveyor F and prezones V, two of the lifts L1, L2 and L3, L4, respectively, are, in each case, connected to one of the conveyor levels FE1, FE2. At the first (upper) conveyor level FE1, the lifts L1, L2 are operated, at the second (lower) conveyor level FE2, the lifts L3, L4 are operated. This shelf storage system 1″ is a high-performance system which demonstrates the scalability of the present invention. Since not all lifts are connected to all conveyor levels, but there are only two lifts per each conveyor level, conveyor components are saved. Nevertheless, it is possible to access every storage space in the shelves R1, R2, R3, R4 from every conveyor level FE1, FE2.

In FIGS. 4A, 4B and 4C, a fourth embodiment of a shelf storage system 1′″ according to the invention is depicted which differs from the previous embodiments again only by the design of the conveyor F and the prezone V. In FIGS. 4A, 4B and 4C, equal or similar parts of the shelf storage system 1′″ are provided with the same reference characters as in the first embodiment of the shelf storage system 1. With regard to a description of those equal or similar parts, the first embodiment is indicated.

In the shelf storage system 1′″, the conveyor F connected to the lifts L1, L2 comprises two conveying tracks 15, 16 with a conveying direction toward the lifts L1, L2 as well as one conveying track 17 with a conveying direction away from the lifts L1, L2. This conveying track 17 conveying away from the lifts L1, L2 is arranged between the conveying tracks 15, 16 conveying toward the lifts and also between the lifts L1, L2. Shunting means RM between the lift and the conveying tracks 15, 16, 17 serve for receiving a product P from a lift platform 7, 8, 9, 10 located at the height of the conveying tracks 15, 16 and moving it in a transverse direction to the conveying tracks toward the removing conveying track 17 and transferring it onto said conveying track 17.

In the shelf storage system 1″′, the prezone V comprises two unidirectional conveyor belts 18, 19 arranged side by side and at different heights. One conveyor belt 18 has a transfer station 22 in which products P can be received by the removing conveying track 17. The other conveyor belt 19 has two transfer stations 20, 21 by means of which products can be transferred onto the supplying conveying tracks 15, 16.

In a variant of the shelf storage system 1′″ which is illustrated schematically in side view in FIG. 5, two conveying tracks 15′, 16′ conveying toward the lift (lift L2 can be seen in the drawing) and one conveying track 17′ conveying away from the lift are provided per lift L1, L2, wherein the conveying track 17′ conveying away from the lift is arranged between the conveying tracks 15′, 16′ conveying toward the lift. The vertical distance d4 between the conveying tracks 15′, 17′ and 16′, 17′, respectively, corresponds to the vertical distance d2 between the lift platforms 9, 10. In this variant, shunting means are not required. The respective lift (herein lift L2) can be placed in two transfer positions of different heights. In the first, higher transfer position, the lift platforms 9, 10 are located at the height of the two higher conveying tracks 15′, 17′, with the upper lift platform 10 being located opposite to the supplying conveying track 15′ and the lower lift platform 9 being located opposite to the removing conveying track 17′. In this position, a product can be transferred onto the upper lift platform 10 and, at the same time, a different product can be transferred from the lower lift platform 9 onto the removing conveying track 17′. In the second, lower transfer position (not illustrated here), the upper lift platform 10 is located opposite to the removing conveying track 17′, and the lower lift platform 9 is located opposite to the supplying conveying track 16′. In this position, a product can be transferred onto the lower lift platform 9 and, at the same time, a different product can be transferred from the upper lift platform 10 onto the removing conveying track 17′. A further advantage of this embodiment is that the control can be effected such that only the upper lift platform moves to the uppermost shelf level for placing products in storage and removing them from storage and only the lower lift platform moves to the lowermost shelf level for placing products in storage and removing them from storage. Hence, a reduction in overall height can be achieved since it is not necessary to ensure that both lift platforms reach all shelf levels.

All specified embodiments of the shelf storage system according to the invention have a bidirectional connection of all lifts L1-L4 to the conveyor F. As a result, all lifts are able to receive receptacles from the conveyor as well as to deliver them to the latter, whereby all lifts can be operated independently of each other both for placing products in storage and for removing them from storage. In one extreme case, products are stored in the shelves using all lifts at the same time. In another extreme case, products are taken from the shelves and transferred to the conveyor using all lifts at the same time. Any distribution between these extreme cases can also be implemented in terms of control technology.

A further advantage of the twofold connection of the lifts is that two lift platforms per lift can be arranged at a shelf-level distance and the conveyor can also be erected at said distance. In this way, it becomes possible that, per lift, the conveyor transfers a product to the lift and simultaneously takes another one from the lift. The same is possible at adjacent shelf levels. In this way, a considerable increase in throughput can be achieved, since the transfer times for products to be removed and to be transferred do not add up at the lift. However, seen from the point of view of control technology, it is easier, albeit not essential, to go without the double cycle during the transfer to and from the shelf, respectively, and to utilize only the temporal advantage of the simultaneous loading and unloading of the lift at the conveyor.

1. A shelf storage system comprising:
shelves having several shelf levels arranged on top of each other with storage spaces for products,
movable level operating devices for moving to the storage spaces, comprising at least two lifts for taking products to the shelf levels and fetching them from the shelf levels,
a conveyor for supplying products to the lifts and removing them from there, and
intermediate buffers in the shelf levels, in which intermediate buffers products supplied by the lifts are stored temporarily until they are transferred onto the level operating device and in which products taken from storage spaces by the level operating device are stored temporarily until they are transferred to the lifts, wherein:
the lifts are, in each case, connected both to a supplying and to a removing conveyor and are, in each case, designed both for receiving products from the conveyor and for supplying these products to the shelf levels and for removing products from the shelf levels and transferring these products onto the conveyor.

2. A shelf storage system according to claim 1, wherein the conveyor connected to the lifts comprises conveying tracks with reversible conveying directions.

3. A shelf storage system according to claim 1, wherein the conveyor connected to the lifts comprises conveying tracks with a conveying direction toward the lifts and one or more conveying tracks with a conveying direction away from the lifts.

4. A shelf storage system according to claim 1, wherein at least one of the lifts is equipped with at least two lift platforms for carrying products.

5. A shelf storage system according to claim 4, wherein the conveyor is arranged such that, in at least one transfer position of the lift, at least two lift platforms are connected to conveying tracks.

6. A shelf storage system according to claim 4, wherein the lift platforms are arranged on top of each other, wherein, preferably, the vertical distance between the lift platforms corresponds to the vertical distance between the shelf levels.

7. A shelf storage system according to claim 6, wherein the conveying tracks are arranged on top of each other, wherein the vertical distance between at least two conveying tracks corresponds to the vertical distance between the lift platforms.

8. A shelf storage system according to claim 7, wherein two conveying tracks conveying toward the lift and one conveying track conveying away from the lift are provided per lift, wherein the conveying track conveying away from the lift is arranged between the conveying tracks conveying toward the lift.

9. A shelf storage system according to claim 1, wherein the conveyor is arranged at several conveyor levels the lifts can be moved to.

10. A shelf storage system according to claim 2, wherein the conveyor connected to the lifts comprises conveying tracks with a conveying direction toward the lifts and one or more conveying tracks with a conveying direction away from the lifts.

11. A shelf storage system according to claim 10, wherein the conveyor connected to the lifts comprises two conveying tracks conveying toward the lift and only one conveying track conveying away from the lift are provided per lift.

12. A shelf storage system according to claim 3, wherein the conveyor connected to the lifts comprises two conveying tracks conveying toward the lift and only one conveying track conveying away from the lift are provided per lift.

13. A shelf storage system according to claim 2, wherein at least one of the lifts is equipped with at least two lift platforms for carrying products.

14. A shelf storage system according to claim 3, wherein at least one of the lifts is equipped with at least two lift platforms for carrying products.

15. A shelf storage system according to claim 4, wherein at least one of the lifts is equipped with at least two lift platforms for carrying products.

16. A shelf storage system according to claim 2, wherein the conveyor is arranged at several conveyor levels the lifts can be moved to.

17. A shelf storage system according to claim 3, wherein the conveyor is arranged at several conveyor levels the lifts can be moved to.

18. A shelf storage system according to claim 4, wherein the conveyor is arranged at several conveyor levels the lifts can be moved to.

19. A shelf storage system according to claim 5, wherein the conveyor is arranged at several conveyor levels the lifts can be moved to.

20. A shelf storage system according to claim 6, wherein the conveyor is arranged at several conveyor levels the lifts can be moved to.

21. A shelf storage system according to claim 7, wherein the conveyor is arranged at several conveyor levels the lifts can be moved to.

22. A shelf storage system according to claim 8, wherein the conveyor is arranged at several conveyor levels the lifts can be moved to.
